(19) United States
(12) Patent Application Publication
(10) Pub. No.: US 2002/0120643 A1
(43) Pub. Date: Aug. 29, 2002

(54) Audio-visual data collection system

(75) Inventors: Giridharan Iyengar, Mohegan Lake, NY (US); Chalapathy Neti, Yorktown Heights, NY (US); Michael A. Picheny, White Plains, NY (US); Gerasimos Potamianos, White Plains, NY (US)

Correspondence Address: FERENCE & ASSOCIATES, 129 Oakhurst Road, Pittsburgh, PA, 15215, US

(73) Assignee: IBM Corporation

(21) Appl. No.: 09/796,586

(22) Filed: Feb. 28, 2001

(51) Int. Cl. G09G 5/12; G06F 17/00

(52) U.S. Cl. 707/500.1

(57) ABSTRACT

Methods and apparatus for obtaining visual data in connection with speech recognition. An image capture device captures visible images, a text-supplying device supplies text, and a substantially fully frontal image of a human face is captured during the reading of text from the text-supplying device.

### FIELD OF THE INVENTION

The present invention relates generally to methods and apparatus for collecting visual data, such as facial data that may be recorded as an individual is speaking.

### BACKGROUND OF THE INVENTION

The act of combining visual speech with audio-based speech recognition has been found to be a promising approach to improve speech recognition in presence of acoustic degradation, as discussed in copending and commonly assigned U.S. Patent Application Ser. No. 09/369,707, filed Aug. 6, 1999, entitled “Method and apparatus for audio-visual speech detection and recognition”. Generally, in order to train recognition systems to utilize both visual and acoustic representations of speech, it is necessary to collect time-synchronized audio and visual data while people are speaking. In particular, it is necessary to capture near-frontal images of people so that useful visual speech data can be extracted from the images.

Experiments in face detection have suggested that extremely good visual speech data can be collected for near-frontal poses of speakers and deviations in frontality can cause significant reductions in face detection accuracy, thereby drastically reducing the of visual speech representations. For example, frontal conditions (i.e. facial pose variations limited to approximately +/−10 degrees from the frontal plane) have been found to provide almost-perfect face detection accuracy (99.7% detection) while, under larger (greater than +/−10 degree) pose variations the accuracy drops to approximately 58%. Thus, though some small improvements continue to be made in face detection and visual speech representations from non-frontal (i.e., greater than +/−10 degree) angles, it still appears to be the case that the extraction of frontal pose images from exactly frontal or almost exactly frontal angles for training data is highly desirable, if not critical.

While a relationship has been discerned between face detection accuracy and variations in pose, significant improvements in visual speech accuracy have also been observed when good visual speech representations have been accurately extracted. For example, it has been found that when the accuracy of detection of the lips is greater than about 90%, good visual speech accuracy is the result, with performance degrading steadily as the percentage of accurate lip detection drops. If the accuracy of lip detection is below 50% , it has been found that the resulting visual speech information is of little or no informational value.

Accordingly, it has been found to be highly desirable, if not crucial, to collect near-frontal images which imply good facial feature detection, preferably using state of the art face detectors.

To capture near-frontal images while a subject is speaking, it is generally necessary to display the text to be read such that the subject is directly looking at the camera. In addition, it is desirable to display a preview image of the captured data so that the data-collector can ensure that the right image/data is being captured.

However, it has been found that managing the subject's position relative to the camera, ensuring proper recording of the audio/video, and keeping track of the proper numbering of the recorded utterance and its associated text can be extremely taxing for the data collector and is a frequent source of mistakes.

A need has been recognized in connection with providing good visual speech data in which such mistakes are minimized.

### SUMMARY OF THE INVENTION

In accordance with at least one presently preferred embodiment of the present invention, broadly contemplated is a system that displays the text to be read on a teleprompter mounted on a video camera, records the audio/video of the subject and manages the bookkeeping of recorded data and text using a minimum of effort, e.g., two clicks on a computer mouse. It is conceivable that, as a result, the need for a data-collecting individual will be eliminated.

In summary, one aspect of the invention provides a method of obtaining visual data in connection with speech recognition, the method comprising the steps of:

providing an image capture device which captures visible images; providing a text-supplying device which supplies text; providing an arrangement for controlling the text-supplying device; capturing a substantially fully frontal image of a human face during the reading of text from the text-supplying device.

Another aspect of the invention provides an apparatus of obtaining visual data in connection with speech recognition, the apparatus comprising: an image capture device which captures visible images; a text-supplying device which supplies text; an arrangement for controlling the text-supplying device; wherein the image capture device is adapted to capture a substantially fully frontal image of a human face during the reading of text from the text-supplying device.

Furthermore, and additional aspect of the invention provides a program storage device readable by machine, tangibly embodying a program of instructions executable by the machine to perform method steps for obtaining visual data in connection with speech recognition the method comprising the steps of: providing an image capture device which captures visible images; providing a text-supplying device which supplies text; providing an arrangement for controlling the text-supplying device; capturing a substantially fully frontal image of a human face during the reading of text from the text-supplying device.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a schematic illustration of a visual data collection system.

FIG. 2 is a flow diagram of a process for utilizing a visual data collection system.

### DESCRIPTION OF THE PREFERRED EMBODIMENTS

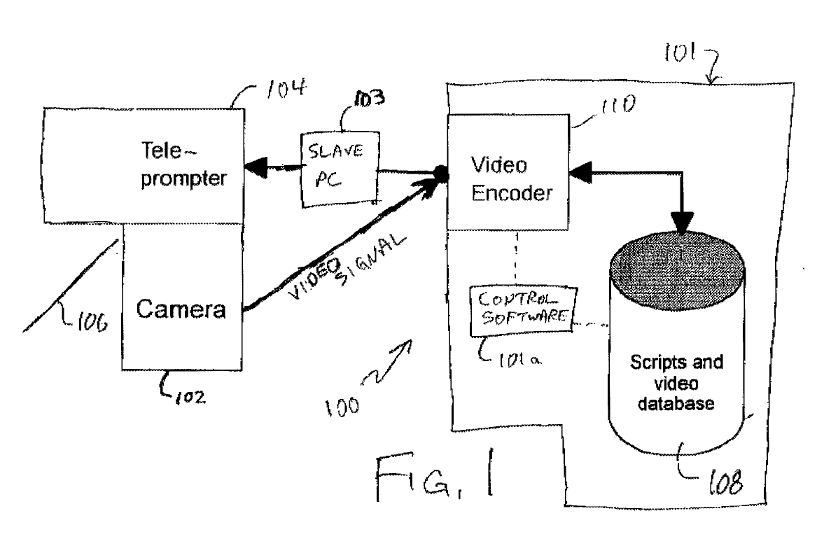

In accordance with a preferred embodiment of the present invention, and with reference to FIG. 1, a system 100 for collecting visual data preferably includes a video camera 102, a teleprompter 104, 2 PC's (101, 103) communicating via the TCP/IP protocol (i.e., Transmission Control Protocol/Internet Protocol) protocol and the in-house data collection application. The teleprompter 104 is preferably mounted on the video camera 102 and positioned such that the displayed text on the teleprompter forces the subject to be directly looking into the camera 102. This can be achieved, for instance, by means of a partially reflecting mirror 106 mounted at 45 degrees directly in front of the camera. Thus, text or images from the teleprompter 104 would preferably be reflected onto the 45-degree mirror 106, while the partially reflecting nature of the mirror 106 itself would allow for the camera 102 to still capture images from the subject's face despite the image having to be transmitted back through the mirror 106. It should be appreciated that partially-reflecting mirrors exist, for use as mirror 106, that would ensure that the teleprompter text on the reflective side of mirror 106 would not interfere with image collection, in that the degradation to the captured image would be very minor. Preferably, teleprompter 104 may be placed below the mirror 106 to project onto mirror 106 but, as shown in FIG. 1, it may also be placed above mirror 106.

The teleprompter 104 is preferably driven by one of the PC's (hereby referred to as the slave PC 103). Slave PC 103 is preferably interposed between a main PC 101 and the teleprompter 104, and preferably “talks” with the main PC 101 via TCP/IP. The main PC 101, which houses the data capture device, the data collection application and the script-and-subject (or script and video) database 108, is preferably connected to the video camera (through digitization hardware at a video encoder 110) recording the subject. Control software 101a is preferably provided, and adapted, to appropriately control database 108 and video encoder 110. An operator may perform basic book keeping tasks, such as selecting the script of sentences to be played to the teleprompter, entering subjects' data and starting/stopping the recording session.

Using only two-clicks, e.g. via a computer mouse, the system 100 may preferably be adapted to send a sentence or other suitable block of text to the teleprompter 104 (via the slave PC), record the video (of the subject uttering the sentence originating from teleprompter 104 and displayed on mirror 106) through camera 102 and save the collected data, with appropriate markers (e.g., quality of audio, clarity of speech, the original sentence spoken, etc.) in database 108. Preferably, the first click will prompt the sending of the sentence and commencement of the video recording. The second click will preferably prompt acceptance of the recording and advancement of the sentence pointer to the next sentence. At this point, the second click may also involve rejecting the recording, staying in the same sentence or skipping to the next sentence and thus discarding the recording.

Accordingly, with a first click, the system preferably:

reads the current sentence of text from a file containing multiple sentences;

communicates the text to the 2nd PC via the network using a TCP/IP protocol;

displays the text on teleprompter 104/mirror 106 (so that the subject is directly

facing the camera 102 while reading the text); and

starts recording the audio and video data.

With a second click, the system may selectably accept, skip, or repeat the recording. One button for each choice may preferably be provided on the computer screen being utilized.

If accepted, the current recording is stored, the filename is automatically incremented and an internal sentence pointer in the control software 101a is preferably incremented to the next script sentence. Preferably, only one sentence is sent to the teleprompter at a time.

If repeated, the same filename is maintained and the sentence pointer is maintained at its current position.

If skipped, the current recording is deleted, the filename is incremented, and the sentence pointer is incremented.

In addition, the system 100 is preferably adapted to store any intermediate state of data collection so that the collection process can be suspended at any point and resumed from the same point without additional inputs from the operator or subject.

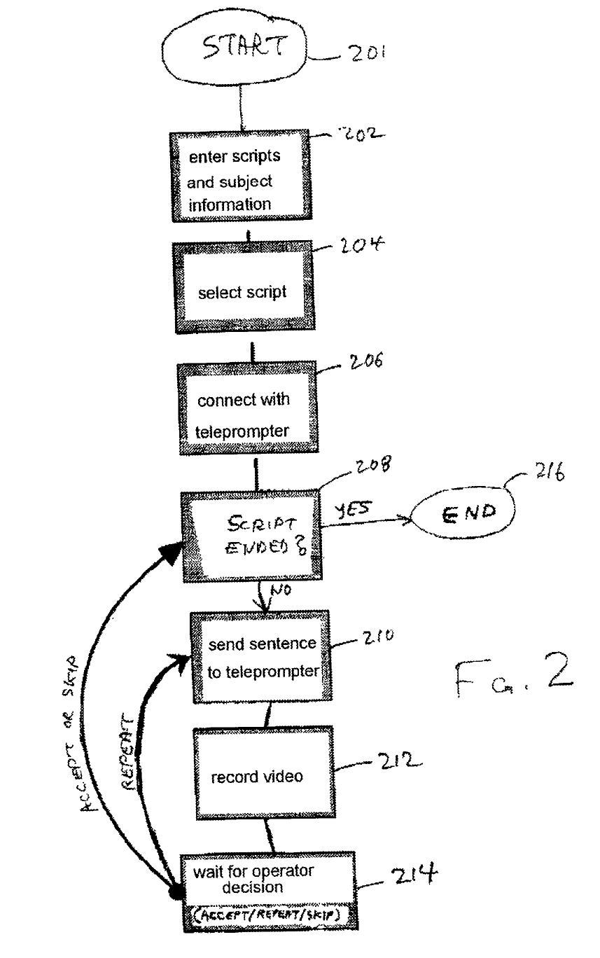

FIG. 2 schematically illustrates a general process that may be employed in accordance with at least one presently preferred embodiment of the present invention. Simultaneous reference will also be made to FIG. 1 where appropriate.

After the process starts (201), at step 202, a collection of potential scripts to used, as well as information on the subject to be recorded (e.g., name, whether or not a native speaker of English, amount of English language schooling, place of birth, place of initial schooling, place of higher education if any) are preferably entered into database 108. At step 204, a script is preferably selected from database 108 by the operator or the person being experimented upon. Active connection with teleprompter 104 is preferably undertaken at step 206. If the script has not yet ended (query 208), a sentence is sent to teleprompter 104 (step 210), preferably prompted by the aforementioned “first click”. Video is then preferably recorded at step 212 as the subject utters the sentence appearing on the teleprompter 104. Thence, the operator, or even the subject being recorded, decides at step 214, preferably via the aforementioned “second click”, whether to accept, repeat or skip (as defined further above) the sentence just recorded. If “repeat” is chosen, then the process automatically reverts to step 210. Otherwise, back at step 208, if it is determined that the script has not ended, only then will the process starts anew at step 210. If, however, it is determined that the script has indeed ended, then the process itself ends (step 216).

It will be appreciated that, heretofore, teleprompting was essentially used primarily for broadcast news and the film industry. It is believed that the use of such a system for audio-visual data collection, as described herein, is a significant innovation.

It will also be appreciated that face detection and facial feature detection improves very significantly with frontal or virtually frontal face data, which leads to tremendous improvements in the quality of visual speech representation.

It should additionally be appreciated that, since TCP/IP is used to send messages in accordance with at least one presently preferred embodiment of the present invention, it is possible to position the subject (i.e., the individual being experimented upon) and the camera in a remote location as compared to the controlling PC 101. Thus, the PC 101 would not need to be in the immediate vicinity of camera/teleprompter 102/104, and in fact could be disposed miles away or even in a different country.

It has been found that a system such as that described hereinabove can save a tremendous amount of time and dramatically reduce data collection errors.

It is to be understood that the present invention, in accordance with at least one presently preferred embodiment, includes an image capture device which captures visible images, a text-supplying device which supplies text, and an arrangement for controlling said text-supplying device. Together, the image capture device, text-supplying device and controlling arrangement may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method of obtaining visual data in connection with speech recognition, said method comprising the steps of:
providing an image capture device which captures visible images;
providing a text-supplying device which supplies text;
providing an arrangement for controlling said text-supplying device;
capturing a substantially fully frontal image of a human face during the reading of text from said text-supplying device.

2. The method according to claim 1, further comprising the step of integrating said image capture device with said text-supplying device in a manner to enable the substantially fully frontal image capture of a human face during the reading of text from said text-supplying device.

3. The method according to claim 1, wherein said capturing step comprises capturing a frontal image of a human face that diverges by less than or equal to about +/−10 degrees from full frontality.

4. The method according to claim 1, wherein said step of providing a text-supplying device comprises providing a teleprompter.

5. The method according to claim 4, further comprising the step of integrating the image capture device with said teleprompter in a manner to enable the substantially fully frontal image capture of a human face during the reading of text from said text-supplying device.

6. The method according to claim 5, wherein said integrating step comprises fixedly mounting said teleprompter with respect to said image capture device.

7. The method according to claim 6, further comprising the step of providing a reflector arrangement which reflects text from said teleprompter towards the human face whose image is being captured.

8. The method according to claim 7, wherein said step of providing a reflector arrangement comprises mounting said reflector arrangement in front of said image capture device.

9. The method according to claim 8, wherein said step of providing a reflector arrangement comprises configuring said reflector arrangement such that it simultaneously permits image capture while reflecting text from said teleprompter.

10. The method according to claim 1, wherein said step of providing a controlling arrangement comprises providing an arrangement for selectively admitting delimited blocks of text one at a time to said text-supplying device.

11. The method according to claim 1, wherein said step of providing an arrangement for selectively admitting delimited blocks of text comprises providing a selector arrangement accessible to an individual whose face image is being captured by said image capture arrangement.

12. A apparatus of obtaining visual data in connection with speech recognition, said apparatus comprising:
an image capture device which captures visible images;
a text-supplying device which supplies text;
an arrangement for controlling said text-supplying device;
wherein said image capture device is adapted to capture a substantially fully frontal image of a human face during the reading of text from said text-supplying device.

13. The apparatus according to claim 12, wherein said image capture device is integrated with said text-supplying device in a manner to enable the substantially fully frontal image capture of a human face during the reading of text from said text-supplying device.

14. The apparatus according to claim 12, wherein said image capture device is adapted to capture a frontal image of a human face that diverges by less than or equal to about +/−10 degrees from full frontality.

15. The apparatus according to claim 12, wherein said text-supplying device comprises a teleprompter.

16. The apparatus according to claim 15, wherein said image capture device is integrated with said teleprompter in a manner to enable the substantially fully frontal image capture of a human face during the reading of text from said text-supplying device.

17. The apparatus according to claim 16, wherein said teleprompter is fixedly mounted with respect to said image capture device.

18. The apparatus according to claim 17, further comprising a reflector arrangement which reflects text from said teleprompter towards the human face whose image is being captured.

19. The apparatus according to claim 18, wherein said reflector arrangement is mounted in front of said image capture device.

20. The apparatus according to claim 19, wherein said reflector arrangement is configured such that it simultaneously permits image capture while reflecting text from said teleprompter.

21. The apparatus according to claim 12, wherein said controlling arrangement is adapted to selectively admit delimited blocks of text one at a time to said text-supplying device.

22. The apparatus according to claim 21, wherein controlling arrangement comprises a selector arrangement accessible to an individual whose face image is being captured by said image capture arrangement.

23. A program storage device readable by machine, tangibly embodying a program of instructions executable by the machine to perform method steps for obtaining visual data in connection with speech recognition, said method comprising the steps of:
providing an image capture device which captures visible images;
providing a text-supplying device which supplies text;
providing an arrangement for controlling said text-supplying device;
capturing a substantially fully frontal image of a human face during the reading of text from said text-supplying device.
